(19) United States
(12) Patent Application Publication
(10) Pub. No.: US 2003/0185352 A1
(43) Pub. Date: Oct. 2, 2003

(54) Automated message broadcast system with dual message sources

(76) Inventors: Brian Savage, Tualatin, OR (US); Gregory S. Wexler, Encino, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/108,528

(22) Filed: Mar. 27, 2002

(51) Int. Cl. H04M 1/64

(52) U.S. Cl. 379/67.1; 379/76

(57) ABSTRACT

A method for delivering pre-recorded telephone messages comprises dialing a telephone number to initiate a telephone call to a recipient, and monitoring the telephone call to determine whether the telephone call is not answered, is answered by an automated answering service, or is answered by a live human. If the telephone call is answered by an automated answering service, a first pre-recorded message from a first message source is played. If the telephone call is answered by a live human, a second pre-recorded message from a second message source is played.

### BACKGROUND OF THE INVENTION

1. Field of the Invention

The present invention relates to automated telephone message broadcast systems capable of delivering messages from different sources, where the message delivered depends on whether the telephone call is answered by a human or by a machine, and on the demographic profile of the individual or individuals at the telephone number called.

2. Description of the Related Art

Automated telephone dialing services are commonly used to deliver pre-recorded voice messages to each party on a prepared list of telephone numbers. Such services are often used to distribute pre-recorded promotional messages, solicitations for sales, or emergency messages to a large number of recipients in an efficient manner. Automating the message delivery system eliminates the need to employ a large number of live human telephone operators, thereby reducing labor costs and ensuring that a uniform and consistent message is delivered to each recipient. Automation of the message delivery process also decreases the amount of time required to broadcast the message to a large number of recipients. An example of such an automated message broadcast system is described in U.S. Pat. No. 6,226,360.

The practical utility of automated telephone dialing services to deliver pre-recorded voice messages has been significantly decreased by the widespread use of automated telephone answering machines and voicemail systems (hereinafter referred to collectively as “automated answering services”). Specifically, lengthy pre-recorded messages may be played out while the automated answering service is playing a greeting, and before the automated answering service begins recording. Such a result obviously significantly lessens the cost-effectiveness and efficiency of using an automated telephone dialing service to deliver pre-recorded voice messages.

Consequently, automated message broadcast systems capable of recognizing whether a telephone call has been answered by an automated answering service or by a live human being have been developed. Examples of such recognition systems are described in U.S. Pat. Nos. 4,941,168 and 5,638,436. Once it is determined whether a telephone call has been answered by an automated answering service or by a live human being, the timing of the playback of the pre-recorded message may be adjusted accordingly. For example, if an automated answering service answers the telephone call, the pre-recorded message should be played only after a tone or period of silence is detected (indicating that the automated answering service has commenced recording). Alternatively, if a live human answers the telephone call, the pre-recorded message should begin playing within one to four seconds of initial call connection, which is the typical length of a normal “Hello”.

In certain circumstances, depending on whether an automated answering service or a live human answers a telephone call, it may be desirable to alter not only the timing of the playback of the pre-recorded message, but the content of the pre-recorded message as well. For example, it may be desirable for an organization broadcasting messages to play a short message if an automated answering service answers the telephone call, and to play a longer, more detailed message if a live human answers the telephone call. This is partially due to the fact that some automated answering services may “time-out” and stop recording after a certain amount of time, thereby causing a longer message to be truncated. Thus, systems have been developed to alter the timing of the playback of the pre-recorded message based on how the telephone call has been answered.

In addition, message broadcasters may wish to deliver their pre-recorded messages to live humans only or to automated answering services only. For example, if an automated answering service answers a telephone call intended for a live human recipient, the telephone call is disconnected and the automated answering service records a period of silence. Alternatively, if a live human being answers a telephone call intended for an automated answering service, the telephone call is disconnected and the live human hears silence. These circumstances are commonly referred to as “call abandonment.” Call abandonment is inefficient, annoying, and even unlawful in certain jurisdictions. Therefore, an improved automated dialing system that reduces or eliminates call abandonment is desired.

In other circumstances, message broadcasters may wish to deliver a pre-recorded message that is specifically tailored to the recipient. For example, it may be desired to deliver a certain pre-recorded message to all homeowners (i.e., a message advertising homeowners' insurance), while delivering a separate pre-recorded message to people who rent or lease their residence (i.e., a message advertising renters' insurance). Conventional message broadcast systems deliver a single message to all recipients regardless of the recipients' demographic characteristics. Therefore, an improved automated dialing system that delivers a pre-recorded message that is specifically tailored to the recipient based on the recipient's demographic characteristics is desired.

### SUMMARY OF THE INVENTION

One aspect of the present invention is a method for delivering pre-recorded telephone messages comprising dialing a telephone number to initiate a telephone call to a recipient and monitoring the telephone call to determine whether the telephone call is not answered, is answered by an automated answering service, or is answered by a live human. If the telephone call is answered by an automated answering service, a first pre-recorded message from a first message source is played. If the telephone call is answered by a live human, a second pre-recorded message from a second message source is played.

In one embodiment of the present invention, the telephone number is selected from a telephone number database that contains a plurality of telephone numbers that each belong to an intended recipient of the first and second pre-recorded messages. In another embodiment, the telephone number database contains telephone numbers of households within a specified geographic region. In yet another embodiment, the telephone number database contains telephone numbers of households with a specified demographic profile. In yet another embodiment, the called telephone number is stored in a failure list if the telephone call is not answered. In yet another embodiment, the first message source is a commercial organization, while the second message source is a charitable organization or a public service organization.

Another aspect of the present invention is a system for delivering pre-recorded telephone messages comprising a telephone number database containing a plurality of telephone numbers and first and second pre-recorded telephone messages from first and second message sources. A call controller sequentially initiates a telephone call to at least a portion of the telephone numbers stored in the telephone number database, and determines whether each telephone call is not answered, is answered by an automated answering service, or is answered by a live human. A message player plays the first pre-recorded message if the telephone call is answered by an automated answering service, and plays the second pre-recorded message if the telephone call is answered by a live human.

In one embodiment of the present invention, each of the telephone numbers in the telephone number database belongs to an intended recipient of the first and second pre-recorded messages. In another embodiment, the telephone number database contains telephone numbers of households within a specified geographical region. In yet another embodiment, the telephone number database contains telephone numbers of households with a specified demographic profile. In yet another embodiment, a failure list contains telephone numbers to which a pre-recorded message was not delivered. In yet another embodiment, the first message source is a commercial organization, and the second message source is a charitable organization or a public service organization.

### BRIEF DESCRIPTION OF THE DRAWINGS

The preferred embodiments of an improved automated message broadcast system, illustrating its features, will now be discussed in detail. These embodiments depict the novel and non-obvious improved automated message broadcast system shown in the accompanying drawings, which are for illustrative purposes only. These drawings include the following figures, in which like numerals indicate like parts.

FIG. 1 is a schematic diagram of one embodiment of an improved automated message broadcast system.

FIG. 2 is a flowchart illustrating the operation of another embodiment of an improved automated message broadcast system.

### DETAILED DESCRIPTION OF THE PREFERRED EMBODIMENTS

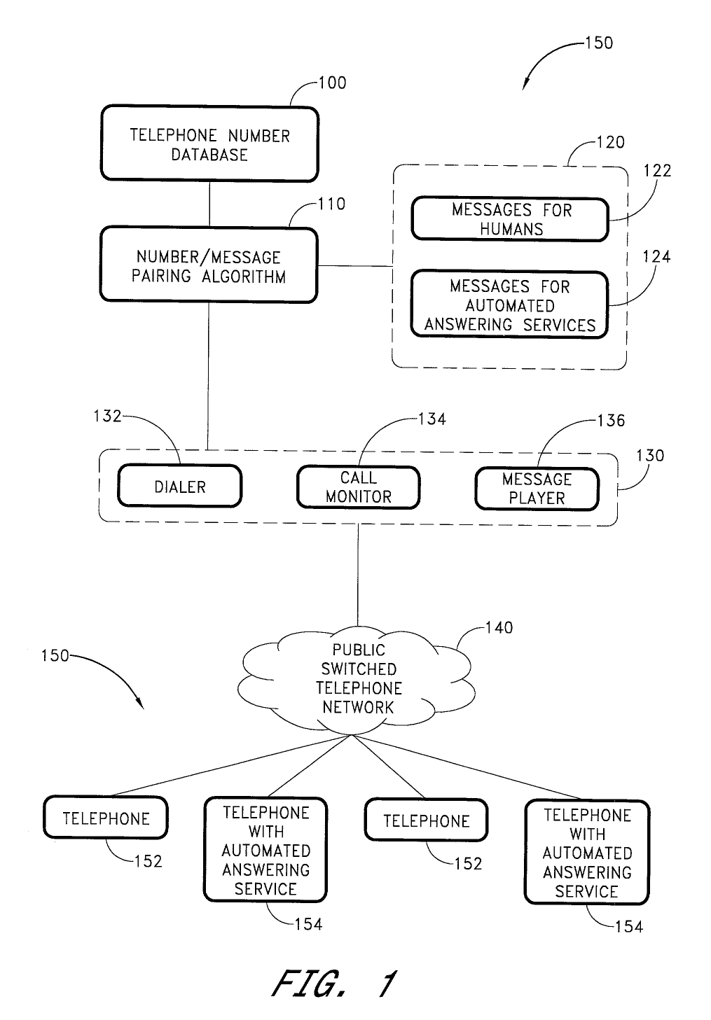

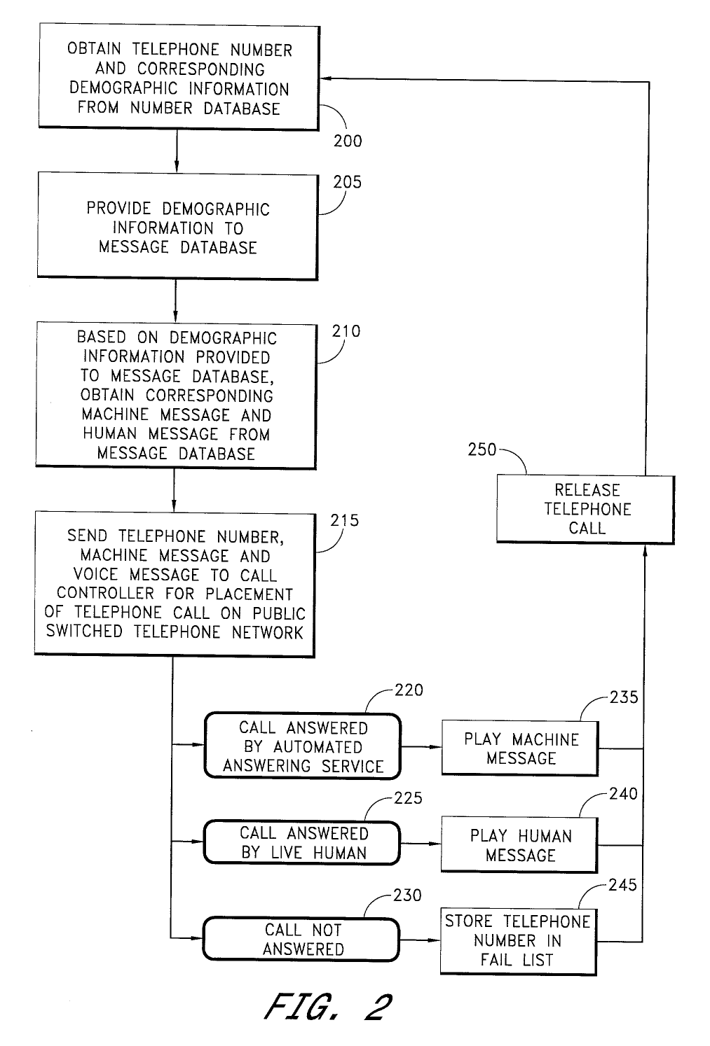

FIGS. 1 and 2 illustrate a method for delivering pre-recorded telephone messages using an improved automated message broadcast system. In a preferred embodiment, this method comprises dialing a telephone number of an intended recipient and monitoring the telephone call to determine whether the telephone call is not answered, is answered by an automated answering service, or is answered by a person. If the telephone call is answered by an automated answering service, a first pre-recorded message from a first message source is played; if the telephone call is answered by a person, a second pre-recorded message from a second message source is played.

As illustrated in FIG. 1, in certain embodiments the automated message delivery system includes a telephone number database 100 containing a plurality of telephone numbers. The telephone number database 100 preferably comprises telephone numbers of intended recipients of pre-recorded messages. The telephone numbers comprising the telephone number database 100 may be categorized by a wide variety of criteria, such as demographic criteria (i.e., all households including a married couple, or all households with an aggregate annual income greater than $50,000), or geographic criteria (i.e., all households within a certain postal code, or within a certain political district). In alternative embodiments, the telephone numbers included in the telephone number database 100 are not limited to demographic or geographic classifications; in such embodiments, the telephone number database 100 contains a broader set of telephone numbers.

In other embodiments, the telephone number database 100 further contains demographic information corresponding to each telephone number contained therein. For example, such demographic information may include, but is not limited to, household size, household income, gender, age, or neighborhood. In such embodiments, selection of a telephone number from the telephone number database 100 also provides demographic information about the person or family associated with the selected telephone number.

As illustrated in FIG. 1, in certain embodiments the automated message delivery system further includes a number/message pairing algorithm 110 and a pre-recorded message database 120. The number/message pairing algorithm 110 is adapted to retrieve a “human message” and a “machine message” from the pre-recorded message database 120. As used herein, “human message” refers to a pre-recorded message intended to be played to a live human recipient, while “machine message” refers to a pre-recorded message intended to be played to—and recorded by—an automated answering service. In such embodiments, the pre-recorded database 120 comprises a human message subset 122 wherein at least one human message is stored, and a machine message subset 124 wherein at least one machine message is stored. In alternative embodiments, where the same message is to be played regardless of whether the telephone call is answered by a live person or an automated answering service, the human message subset 122 and the machine message subset 124 include identical messages.

In other embodiments, each of the messages in the pre-recorded message database 120 have associated therewith demographic data corresponding to the target audience of the pre-recorded message. For example, a pre-recorded message advertising luxury automobiles may have associated therewith demographic data characterizing the target market for the luxury automobiles. In such embodiments, the number/message pairing algorithm 110 is adapted to select a pre-recorded message from the pre-recorded message database 120 depending on the demographic information associated with the individual or household at the telephone number selected from the telephone number database 100.

As illustrated in FIG. 1, a preferred embodiment further comprises a call controller 130. In such embodiments, the call controller 130 further comprises a dialer 132, a call monitor 134 and a message player 136. The call controller 130 is adapted to interface with the public switched telephone network (PSTN) 140 to establish a connection with and communicate to one of a plurality of telephones 150. It will be understood by one of ordinary skill in the art that the call controller 130 is not limited to only placing telephone calls to this quantity of telephones. Call controller 130 can place telephone calls to any number of intended recipients depending upon the requirements of the particular application with which the improved automated message delivery system is used. The plurality of telephones 150 may comprise human-answered telephones 152 and/or machine-answered telephones 154.

In such embodiments, the dialer 132 is adapted to place telephone calls over the PSTN 140. The call monitor 134 is adapted to monitor the telephone calls placed by the dialer 132 to determine whether the telephone calls are not answered, are answered by a human, or are answered by an automated answering service. For example, in a preferred embodiment, the call monitor 134 may make this determination using the “Call Progress Analysis” algorithm disclosed in U.S. Pat. No. 5,638,436. The message player 136 is adapted to play either a human message or a machine message based on how the call monitor 134 detects that the telephone call was answered (if at all).

A method for using a preferred embodiment of the improved automated message delivery system is illustrated in the flowchart of FIG. 2. The operational blocks of FIG. 2 will now be explained in detail with respect to a preferred embodiment of the improved automated message delivery system. However, one of ordinary skill in the art will appreciate that additional methods for using the improved automated message delivery system are consistent with the improved automated message delivery system as disclosed herein.

In an operational block 200, the number/message pairing algorithm 110 (FIG. 1) obtains a telephone number from the telephone number database 100. In embodiments where demographic information is also stored in the telephone number database 100, the demographic information associated with the retrieved telephone number is also obtained.

In an operational block 205, the demographic information obtained from the telephone number database 100, if any, is sent to the pre-recorded message database 120. If no demographic information was obtained in operational block 200, then operational block 205 may be omitted.

In an operational block 210, a human message and a machine message are obtained from the human message subset 122 and the machine message subset 124, respectively, of the pre-recorded message database 120. In one embodiment, the two messages obtained from the pre-recorded message database 120 are from two different message sources. As used herein, “message source” refers to the sponsor or creator of the pre-recorded message. For example, the “message source” for a pre-recorded message advertising widgets manufactured by ACME Widget Manufacturing Company would be ACME Widget Manufacturing Company.

The human message obtained from the human message subset 122 may comprise a pre-recorded message soliciting donations for a charitable organization or may comprise a public service announcement; the machine message obtained from the machine message subset 124 may comprise a pre-recorded message advertising a new product. In other embodiments, the two messages obtained from the pre-recorded message database 120 are from the same message source. For example, the human message obtained from the human message subset 122 may comprise a detailed pre-recorded message advertising a new product, while the machine message obtained from the machine message subset 124 may comprise a pre-recorded message briefly summarizing that same new product.

If demographic information was sent to the pre-recorded message database 120 in operational block 205, the messages obtained from the pre-recorded message database 120 in operational block 210 preferably are specifically tailored to the individual about which the demographic information was obtained. For example, if the demographic information sent to the pre-recorded message database in operational block 205 indicates that the selected telephone number is associated with a household with children, the messages obtained from the pre-recorded message database 120 preferably have goods or services useful for parents as a target audience. More specifically, if the demographic information sent to the pre-recorded message database in operational block 205 indicates that the selected telephone number is associated with a household with children, the human message obtained from the human message subset 122 may comprise a pre-recorded message advertising a summer camp, while the machine message obtained from the machine message subset 124 may comprise a pre-recorded message urging parents to teach their children about the perils of drugs and that they should teach their children to “say no to drugs.”

Thus, in embodiments where demographic information is stored in the telephone number database 100, the pre-recorded message database 120 preferably contains more than two pre-recorded messages. However, in certain embodiments, the pre-recorded message database 120 may contain as few as two messages even where demographic information is stored in the telephone number database 100.

In embodiments where no demographic information is stored in the telephone number database 100, the pre-recorded message database 120 contains at least two pre-recorded messages: one machine message from a first message source and one human message from a second message source. In such embodiments, the first message source wishes to broadcast its pre-recorded message only to automated answering services, while the second message source wishes to broadcast its pre-recorded message only to live humans. This configuration eliminates call abandonment by having available for playback an appropriate message regardless of how the telephone call is answered. Alternatively, the two messages in the message database 120 may be different messages from the same message source.

In operational block 215, the telephone number obtained from the telephone number database 100, and the human and machine messages obtained from the human message subset 122 and machine message subset 124, respectively, of the pre-recorded message database 120 are sent to the call controller 130. The dialer 132 then dials the selected telephone number to establish a connection to one of a plurality of telephones 150 across the PSTN 140. After the selected telephone number is dialed, the call monitor 134 monitors the telephone call to determine whether it is not answered, is answered by a live person, or is answered by an automated answering service.

As illustrated in operational blocks 220 and 235 of FIG. 2, if the telephone call is answered by an automated answering service (i.e., the machine-answered telephones 154 in FIG. 1), the message player 136 plays the machine message obtained from the machine message subset 124 of the pre-recorded message database 120 in operational block 210. As illustrated in operational blocks 225 and 240 of FIG. 2, if the telephone call is answered by a live person (i.e., the human-answered telephones 152 in FIG. 1), the message player 136 plays the human message obtained from the human message subset 122 of the pre-recorded message database 120 in operational block 210. As illustrated in operational blocks 230 and 245 of FIG. 2, if the telephone call is not answered after a pre-determined and user-specified period of time, the call controller 130 stores the unanswered telephone number in a “fail list” of numbers to which a pre-recorded message could not be delivered.

After the pre-recorded message is delivered in operational blocks 235 or 240, or after the called telephone number is placed in the “fail list” in operational block 245, the call controller 230 terminates the telephone call in operational block 250. This process may then be repeated, beginning at operational block 200, until all of the telephone numbers in the telephone number database 100 have been called.

The various embodiments of the improved automated message broadcast system described herein address and solve the problems associated with conventional message broadcast systems. The improved automated message broadcast system described herein eliminates call abandonment by pre-selecting pre-recorded messages to be delivered regardless of how the telephone call is answered. More specifically, if a first message source does not wish to leave messages on automated answering systems, the improved automated broadcast system described herein accommodates this need by selecting a machine message from a completely separate second message source for broadcast if an automated answering system answers the telephone call. This configuration eliminates call abandonment, thereby increasing the efficiency of the improved automated message broadcast system, and providing compliance with regulations that prohibit call abandonment.

In addition, the various embodiments of the improved automated message broadcast system allow message broadcasters to delivers pre-recorded messages that are specifically tailored to the recipient. This is accomplished by matching the demographic data associated with the individual or household at selected telephone numbers with specific, narrowly tailored pre-recorded messages stored in the pre-recorded message database 120 in order to increase the effectively of the message broadcasting campaign. Providing a more specifically targeted message to the recipient will increase the overall effectiveness of the improved automated message broadcast system.

### Scope of the Invention

The above presents a description of the best mode contemplated for the present improved automated message broadcast system, and of the manner and process of using it, in such full, clear, concise and exact terms as to enable any person skilled in the art to which it pertains to use this improved automated message broadcast system. This improved automated message broadcast system is, however, susceptible to modifications and alternate constructions from that discussed above which are fully equivalent. Consequently, it is not the intention to limit this improved automated message broadcast system to the particular embodiments disclosed. On the contrary, the intention is to cover all modifications and alternate methods of operation coming within the spirit and scope of the improved automated message broadcast system as generally expressed by the following claims, which particularly point out and distinctly claim the subject matter of the improved automated message broadcast system.

What is claimed is:

1. A method for delivering pre-recorded telephone messages comprising:
dialing a telephone number to initiate a telephone call to a recipient;
monitoring the telephone call to determine whether the telephone call is not answered, is answered by an automated answering service, or is answered by a person;
playing a first pre-recorded message from a first message source if the telephone call is answered by an automated answering service; and
playing a second pre-recorded message from a second message source if the telephone call is answered by a person.

2. The method of claim 1, wherein said telephone number is selected from a telephone number database comprised of a plurality of telephone numbers.

3. The method of claim 2, wherein the telephone number database contains telephone numbers of households within a specified geographical region.

4. The method of claim 2, wherein the telephone number database contains telephone numbers of households with a specified demographic profile.

5. The method of claim 1, further comprising storing the telephone number in a failure list if the telephone call is not answered.

6. The method of claim 1, wherein the first message source is a commercial organization, and the second message source is a charitable organization.

7. The method of claim 1, wherein the first message source is a commercial organization, and the second message source is a public service organization.

8. A system for delivering pre-recorded telephone messages comprising:
a telephone number database containing a plurality of telephone numbers;
a first pre-recorded message from a first message source;
a second pre-recorded message from a second message source;
a call controller adapted to sequentially initiate a telephone call to at least a portion of the telephone numbers stored in the telephone number database and determine whether each telephone call is not answered, is answered by an automated answering service, or is answered by a person; and
a message player adapted to play the first pre-recorded message if the telephone call is answered by an automated answering service, and to play the second pre-recorded message if the telephone call is answered by a person.

9. The system of claim 8, wherein each of the telephone numbers in the telephone number database belongs to a recipient of the first or second pre-recorded messages.

10. The system of claim 9, wherein the telephone number database contains telephone numbers of households within a specified geographical region.

11. The system of claim 9, wherein the telephone number database contains telephone numbers of households with a specified demographic profile.

12. The system of claim 8, further comprising a failure list containing the telephone numbers to which a pre-recorded message was not delivered.

13. The system of claim 8, wherein the first message source is a commercial organization, and the second message source is a charitable organization.

14. The system of claim 8, wherein the first message source is a commercial organization, and the second message source is a charitable organization.
